(19) United States
(12) Patent Application Publication
(10) Pub. No.: US 2024/0380253 A1
(43) Pub. Date: Nov. 14, 2024

(54) POWER NEGOTIATION IN A WIRELESS POWER SYSTEM

(71) Applicant: GE Intellectual Property Licensing, LLC, Niskayuna, NY (US)

(72) Inventors: Jayanti Ganesh, Bangalore (IN); Viswanathan Kanakasabai, Bangalore (IN); Subbarao Tatikonda, Bangalore (IN)

(21) Appl. No.: 18/684,350

(22) PCT Filed: Sep. 22, 2022
(86) PCT No.: PCT/US2022/044440

§ 371 Date: Feb. 16, 2024

(30) Foreign Application Priority Data
Sep. 28, 2021 (IN) 202111043931

(51) Int. Cl. H02J 50/80; H02J 50/12

(52) U.S. Cl. CPC H02J 50/80; H02J 50/12

(57) ABSTRACT

This disclosure provides systems, methods and apparatuses for power negotiation in a wireless power system. The power negotiation enables a Power Transmitter and a Power Receiver to reserve an amount of power that the Power Transmitter can provide to the Power Receiver. The power negotiation technique can account for power transmission losses (PTx-loss) and power reception losses (PRx-loss). During a power negotiation (in a connected phase), a power negotiation value from the Power Receiver to the Power Transmitter accounts for PRx-loss and omits the PTx-loss. The Power Transmitter itself can determine the PTx-loss and adjust the power negotiation value to account for such losses and determine a Negotiated Power level. Thereafter, during the power transfer phase, the Power Receiver can communicate changes to the requested power and the Power Transmitter can account for PTx-loss during control of the wireless power transmission.

### TECHNICAL FIELD

This disclosure relates generally to wireless power, and to power negotiation between a Power Transmitter and a Power Receiver.

### DESCRIPTION OF RELATED TECHNOLOGY

Some wireless power systems utilize wireless power technology to wirelessly provide power to cordless appliances that have a variable load, such as some types of blenders, kettles, air fryers, mixers, etc. In these wireless power systems, a Power Transmitter (sometimes also referred to as a “wireless power transmission apparatus”) may be installed on or included in a countertop, a flat surface, a cooktop, or integrated in a stand-alone wireless power source for table-top usage. A Power Receiver (sometimes also referred to as a “wireless power reception apparatus”) may be included in a cordless appliance. The Power Transmitter may include a primary coil that uses magnetic induction to charge the Power Receiver. For example, the primary coil may produce an electromagnetic field. The Power Receiver may capture the electromagnetic field using a secondary coil and may convert it to electric power or use it for direct induction heating. Thus, the wireless power system can provide wireless power or induction heating to operate a cordless appliance.

A power source (such as a cooktop) may contain multiple Power Transmitters. The Power Transmitters in such a power source typically share a limited power supply—such as a single wall outlet—and therefore typically cannot be operated simultaneously at full power. Exceeding the rated power of the power source can lead to tripping circuit breakers somewhere in the building, which is a highly undesirable situation. There exists a need for a Power Transmitter and a Power Receiver to negotiate an amount of power that the Power Transmitter can provide and that can power the Power Receiver for its intended function.

### SUMMARY

The systems, methods, and apparatuses of this disclosure each have several innovative aspects, no single one of which is solely responsible for the desirable attributes disclosed herein.

One innovative aspect of the subject matter described in this disclosure can be implemented as a method performed by a Power Transmitter. The method may include receiving a power negotiation value (PRx-nego) from a Power Receiver. The method may include estimating, at the Power Transmitter, power transmission losses (PTx-loss) associated with components of the Power Transmitter. The method may include negotiating a Negotiated Power (P-nego) for the Power Receiver based on the PRx-nego and the PTx-loss.

Another innovative aspect of the subject matter described in this disclosure can be implemented as a method performed by a Power Receiver. The method may include communicating a power negotiation value (PRx-nego) to a Power Transmitter. The PRx-nego may be based on a combination of a power rating associated with a load of the Power Receiver and power reception losses (PRx-loss) of the Power Receiver. The method may include negotiating a Negotiated Power (P-nego) with the Power Transmitter based on the PRx-nego. The P-nego represents an amount of power that the Power Transmitter reserves to supply PRx-nego to the Power Receiver.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows a block diagram of an example wireless power system that includes an example Power Transmitter and an example Power Receiver.

FIG. 2 illustrates a perspective view of an example countertop-mounted Power Transmitter.

FIG. 3 illustrates a perspective view of an example countertop-mounted Power Transmitter and an example cordless appliance that includes a Power Receiver.

FIG. 4 shows an example system state diagram with example power negotiation operations.

FIG. 5 shows a block diagram conceptually illustrating an example power negotiation and control.

FIG. 6 shows a block diagram conceptually illustrating an example power negotiation and control that takes into account power transmission losses (PTx-loss) estimated by a Power Transmitter.

FIG. 7 shows a message flow diagram conceptually illustrating an example power negotiation.

FIG. 8 shows a flow diagram illustrating example operations of a process performed by a Power Transmitter.

FIG. 9 shows a flow diagram illustrating example operations of a process performed by a Power Receiver.

FIG. 10 shows a block diagram of an example apparatus for use in wireless power system.

Note that the relative dimensions of the figures may not be drawn to scale.

### DETAILED DESCRIPTION

The following description is directed to certain implementations for the purposes of describing innovative aspects of this disclosure. However, a person having ordinary skill in the art will readily recognize that the teachings herein can be applied in a multitude of different ways. The described implementations can be implemented in any means, apparatus, system, or method for transmitting or receiving wireless power.

A wireless power system may include a Power Transmitter integrated with or otherwise disposed on a surface. The Power Transmitter may include a primary coil that transmits wireless energy (as a wireless power signal) to a corresponding secondary coil in a Power Receiver. For example, the Power Transmitter may include a countertop-mounted primary coil or a primary coil that is embedded or manufactured in a surface on which a Power Receiver can be placed. A primary coil refers to a source of wireless energy (such as inductive or magnetic resonant energy) in the Power Transmitter. A secondary coil located in the Power Receiver may receive the wireless energy and utilize it to charge or power a load or for induction heating. In some implementations, a Power Receiver may be included or integrated with a cordless appliance having a variable load (such as a blender, heating element, a fan, among other examples). In some implementations, the Power Receiver may be included or integrated with a cordless appliance having a fixed load). Some devices (such as cooktops or hobs) may include one or more Power Transmitters to provide wireless power to various Power Receivers. Such devices may use power negotiation to establish an agreed amount of power that a Power Transmitter will reserve for a particular Power Receiver.

This disclosure provides systems, methods and apparatuses for power negotiation between a Power Transmitter and a Power Receiver. Various implementations relate generally a power negotiation value (PRx-nego) that can be used to determine a Negotiated Power (P-nego). The Negotiated Power represents a minimum amount of Available Power that a Power Transmitter has agreed to reserve for a Power Receiver. Available Power refers to the highest amount of Transmitted Power that a Power Transmitter can supply given instantaneous ambient conditions. Ambient conditions include, among others, the Power Transmitter's input power and voltage, its temperature, and the position of the Power Receiver. In accordance with embodiments of this disclosure, a Power Receiver my communicate a power negotiation value that takes into account a power rating of a load associated with the Power Receiver. The power negotiation value also may take into account power reception losses (PRx-loss) associated with components of the Power Receiver. However, the power negotiation value may not include power transmission losses (PTx-loss) associated with components of the Power Transmitter. In some implementations, the Power Transmitter may estimate the PTx-loss and use that value, together with the power negotiation value, to determine the Negotiated Power. The Negotiated Power may be determined during a connected phase, prior to a power transfer phase.

During the power transfer phase, a power controller of the Power Transmitter may determine an operating parameter (such a pulse width modulation setting or voltage control oscillator frequency) to generate a power signal for transmission to the Power Receiver. An Operating Point describes values of the set of variables (such as the operating parameter) that a Power Transmitter uses to drive the power signal. The set of variables typically includes the output voltage, frequency, and duty cycle of the Power Transmitter's inverter. In some implementations, the power controller also may estimate the PTx-loss during power transmission so that operating parameter is adjusted to deliver a Requested Power to the Power Receiver. The Requested Power may represent an amount of transmitted power that the device in which there is a Power Receiver requires to function as intended. The Power Receiver may adjust the Requested Power during the power transfer phase using a power request (P-request) message. In some implementations, the P-request message may be limited by the Negotiated Power (PRx-nego).

In some implementations, the power controller may determine an operating coupling factor (K-factor) between the Power Transmitter and the Power Receiver and adjust the PTx-loss based on the K-factor. An operating K-factor refers to a K-factor based on an actual alignment between the Power Receiver and the Power Transmitter that is currently providing wireless power.

Particular implementations of the subject matter described in this disclosure can be implemented to realize one or more of the following potential advantages. The Power Receiver does not need to estimate or determine PTx-loss when requesting a Negotiated Power. Rather, the Power Transmitter, which is better suited to determine the PTx-loss can account for such power transmission losses when determining whether it can satisfy a requested Negotiated Power. Power negotiation can be done efficiently and effectively between a Power Receiver and a Power Transmitter.

While the examples in this disclosure are based on wireless power used in kitchen systems, the techniques are applicable to other types of systems. For example, the techniques may be used with wireless power systems associated with home appliances, electronic devices, fans, space heaters, speaker systems, air compressors, garden equipment, or components of an electric vehicle, among other examples.

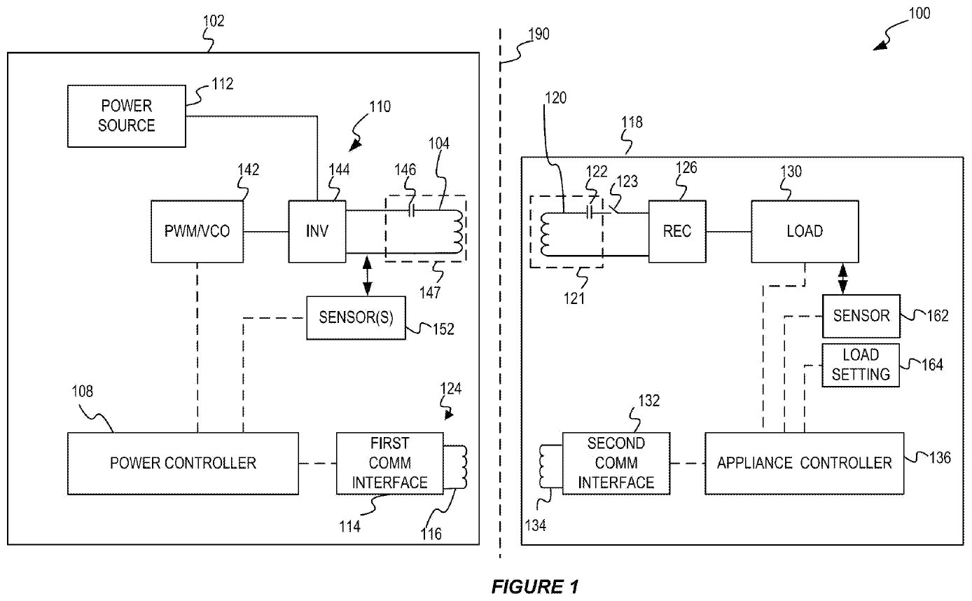

FIG. 1 shows a block diagram of an example wireless power system 100 that includes an example Power Transmitter 102 and an example Power Receiver 118. A Power Transmitter (sometimes referred to as “PTx”) is a functional unit that converts electric power to magnetic power. In this disclosure, the Power Transmitter 102 includes the PTx as well a communication system and other electrical components. A Power Receiver (sometimes also referred to as “PRx”) is a part of a wireless power transfer system that converts magnetic power to electric power or heat. In this disclosure, the Power Receiver 118 includes the PRx as well as a communication system and other electrical components. The Power Transmitter 102 and the Power Receiver 118 may be separated by an interface space 190. In FIG. 1, dashed lines represent communications to distinguish from solid lines that represent electrical circuit lines. The Power Transmitter 102 includes a primary coil 104. The primary coil 104 may be a wire coil which transmits wireless power (which also may be referred to as wireless energy). The primary coil 104 may transmit wireless energy using inductive or magnetic resonant field. The primary coil 104 may be associated with a power transmitter circuit 110. The power transmitter circuit 110 may include components such as a pulse width modulator or voltage controlled oscillator 142, an inverter 144, and a series capacitor 146. The capacitor 146 and the primary coil 104 are sometimes also referred to as an “tank circuit 147”. The power transmitter circuit 110 may also include other components (not shown) for impedance matching. The Power Transmitter 102 also may include one or more sensors 152, such as a voltage sensor and a current sensor (not shown).

Some or all of the power transmitter circuit 110 may be embodied as an integrated circuit (IC) that implements features of this disclosure for controlling and transmitting wireless power to one or more Power Receivers. The power controller 108 may be implemented as a microcontroller, dedicated processor, integrated circuit, application specific integrated circuit (ASIC) or any other suitable electronic device.

The power source 112 may provide power to the power transmitter circuit 110 in the Power Transmitter 102. The power source 112 may convert alternating current (AC) power to direct current (DC) power. For example, the power source 112 may include a converter that receives an AC power from an external power supply and converts the AC power to a DC power used by the power transmitter circuit 110.

The power controller 108 is connected to a first communication interface 114. The first communication interface 114 is connected to a first communication coil 116. In some implementations, the first communication interface 114 and the first communication coil 116 may be collectively referred to as the first communication unit 124. In some implementations, the first communication unit 124 may support Near-Field Communication (NFC). NFC is a technology by which data transfer occurs on a carrier frequency of 13.56 Megahertz (MHz). The first communication unit 124 also may support any suitable communication protocol.

The Power Receiver 118 may include a secondary coil 120, a series capacitor 122, a series switch 123, a rectifier 126, an appliance controller 136, a second communication interface 132, a sensor 162, a load 130, and a memory (not shown). The capacitor 122 and the secondary coil 120 are sometimes also referred to as an “tank circuit 121”. In some implementations, the Power Receiver 118 also may include a user interface (not shown) or other means for obtaining a load setting 164 indicating a desired operation of the load. In some implementations, the load setting 164 may be stored in a memory (not shown) of the Power Receiver 118. In some implementations, the load 130 may also include a drive (not shown) for controlling at least one parameter such as speed or torque of the load. In some implementations, the rectifier 126 may be omitted. In some implementations, a series switch (not shown) may be included in series with the secondary coil 120. Although shown as different components, some components may be packaged or implemented in the same hardware. For example, in some implementations, the appliance controller 136 and a power reception controller (not shown) may be implemented as a single controller. The appliance controller 136, or any combination thereof, may be implemented as a microcontroller, dedicated processor, integrated circuit, application specific integrated circuit (ASIC) or any other suitable electronic device.

An interface space 190 may demark a space between the Power Transmitter 102 and the Power Receiver 118. For example, the interface space may include a surface of the Power Transmitter 102 on which the Power Receiver 118 may be placed. A distance between the primary coil 104 and the secondary coil 120 may include a thickness of a surface in the interface space 190. During wireless power transfer, the primary coil 104 may induce a magnetic field (referred to as the primary magnetic field) through the interface space 190 and into an operative environment in which the secondary coil 120 is placed. Thus, the “operative environment” is defined by the primary magnetic field in the system, where the primary magnetic field of a primary coil 104 is detectably present and can detectably interact with the secondary coil 120.

The power controller 108 may detect the presence or proximity of a Power Receiver 118. This detection may happen during a periodic pinging process of the first communication interface 114 in the Power Transmitter 102. During the pinging process, the first communication interface 114 also may supply power (via the first communication coil 116) to the second communication interface 132 (via the second communication coil 134) when the Power Receiver 118 is in proximity. The second communication interface 132 may “wake up” and power-up the appliance controller 136 and may send a reply signal back to the first communication interface 114. Prior to power transfer, a handshaking process may take place during which the power controller 108 may receive data configuration related to the power rating of the receiver, among other information.

Different cordless appliances have different load types, different load states, and different power requirements or may require power at a particular voltage and frequency. For example, a cordless blender may include a variable motor load that has multiple user-selectable load states to control motor speed. Depending on the load state, the cordless blender may require different levels of power to operate. In another example, a cordless kettle may include a resistive load that has different load states to control temperature. In yet another example, an air fryer may be a compound load device and may operate a heater, a fan, or both, at various periods of operation. Each type of load (such as the motor, the resistive load, the heater, the fan, or any combination thereof) may require different amounts of power to operate based on a current load state or load state. Furthermore, cordless appliances may exhibit different levels of voltage gains from a primary coil to a receiver coil at different primary coil excitation frequencies (such as a wireless power transfer frequency) depending on their load type or load state. For example, to achieve a desired load voltage, a cordless blender may operate best at a first operating frequency for a first load state, such as a low motor speed setting. However, as the load state changes, the cordless blender may not achieve the same load voltage when operated at the first operating frequency. For example, the first operating frequency may facilitate a first voltage gain when the cordless blender is set to a first load state (such as a low-speed setting), but the first operating frequency may provide a lower voltage gain when the cordless blender is set to a second setting (such as a higher-speed setting). The load setting 164 may indicate a current load state or a required power needed for the load to operate in the load state.

The power controller 108 may control characteristics of wireless power that that the Power Transmitter 102 provides to the Power Receiver 118. After detecting the Power Receiver 118, the power controller 108 may receive configuration data from a Power Receiver 118. For example, the power controller 108 may receive the configuration data during a hand shaking process with the Power Receiver 118. The power controller 108 may use the configuration data to determine at least one operating parameter (such as frequency, duty cycle, voltage, etc.) for wireless power generated by the power transmitter circuit 110. The operating parameter may be adjusted based on feedback information from the Power Receiver 118 during the transfer of wireless power in response to a change in the load state or power requirement of the load 130. Thus, the power controller 108 may provide wireless power that enables relatively efficient operation of the Power Receiver 118. For example, the transmission controller may configure the wireless power to enable the Power Receiver to operate at peak efficiency for a particular load state, load voltage and operating K-factor.

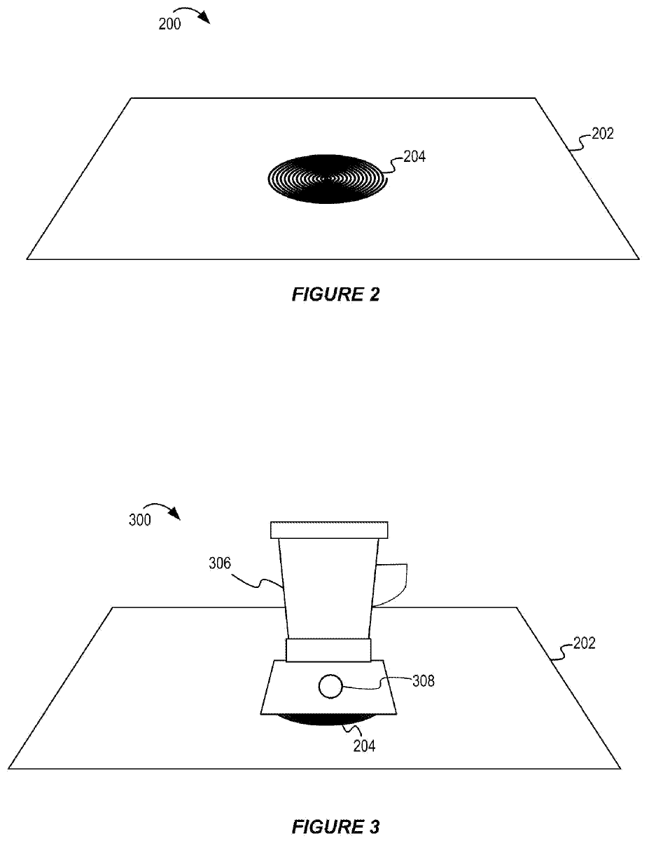

FIG. 2 illustrates a perspective view 200 of an example countertop-mounted Power Transmitter. In some implementations, the Power Transmitter may be coupled with or integrated with a countertop 202. For example, a primary coil 204 of the Power Transmitter may be flush-mounted into the countertop 202. For brevity, only the primary coil 204 of the Power Transmitter is illustrated in FIG. 2. However, other components of the Power Transmitter, such as those describe with reference to FIG. 1, may be integrated or mounted into the countertop 202.

FIG. 3 illustrates a perspective view 300 of an example countertop-mounted Power Transmitter and an example cordless appliance that includes a Power Receiver. The cordless appliance (shown as a blender 306) may be placed on the primary coil 204. The cordless appliance may include a user-selectable load setting 308. The cordless appliance may include a Power Receiver (not shown in FIG. 3). The Power Transmitter and the Power Receiver may include any of the components and functionalities described herein.

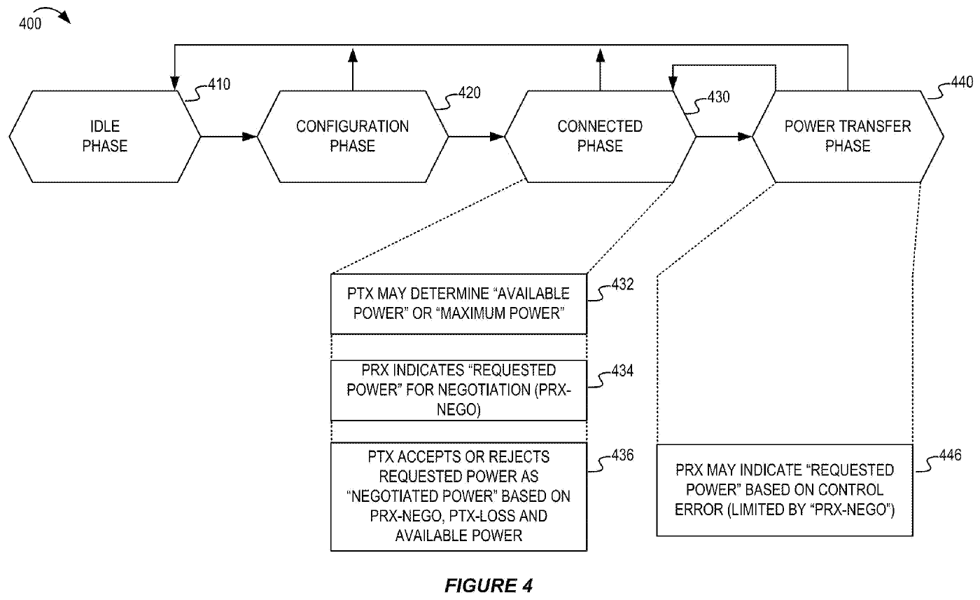

FIG. 4 shows an example system state diagram 400 with example power negotiation operations. The system state diagram 400 consists of four main phases. The Power Transmitter enters the idle phase 410 when the user connects it to the mains. In the idle phase 410, the Power Transmitter looks for the presence of a valid receiver and when detected, establishes communication. In the idle phase 410, the Power Transmitter is in standby until it detects an event that initiates object classification. If the object is a Power Receiver with a communication unit, the Power Transmitter initiates communication then moves to the configuration phase 420. After the activation of the Power Receiver, the Power Transmitter moves into the configuration phase 420 and receives the static configuration data.

In the connected phase 430, the Power Transmitter and Power Receiver exchange information to agree and adjust parameters related to wireless power transfer or wireless charging. In the connected phase 430, the Power Transmitter and Power Receiver negotiate the parameters that govern the power transfer phase. The power negotiation techniques of this disclosure include operations in the connected phase. For example, shown at block 432, the Power Transmitter may determine and the Available Power or the Maximum Power. Shown at block 434, the Power Receiver may indicate a Requested Power for negotiation (PRx-nego). As described in this disclosure, the Requested Power (PRx-nego) may be based on the power rating of the load and power reception losses (PRx-loss). The Requested Power (PRx-nego) may omit or disregard the power transmission losses (PTx-loss) since those will be estimated and added by the Power Transmitter during power negotiation. Shown at block 436, the Power Receiver and the Power Transmitter may negotiate a Negotiated Power (P-nego) based on the Requested Power (PRx-nego_, the estimated PTx loss, and the Available Power. For example, the Power Transmitter may accept or reject the Requested Power (PRx-nego) to conclude the negotiation.

From the connected phase, the Power Receiver can request the Power Transmitter to move to the power transfer phase 440 or back to the idle phase 410. In the Power transfer phase 440, the Power Transmitter performs a Foreign Object Detection (FOD) operation during an FOD slot, then applies the Power Signal, repeating this cycle for the duration of the power transfer phase. Communication or FOD is performed during each Slot. Some examples of the communication in the power transfer phase 440 may be relevant to power negotiation. At block 446, the Power Receiver may communicate a new Requested Power (P-request) based on the control error to cause the Power Transmitter to adjust the amount of power it is transmitting to the Power Receiver.

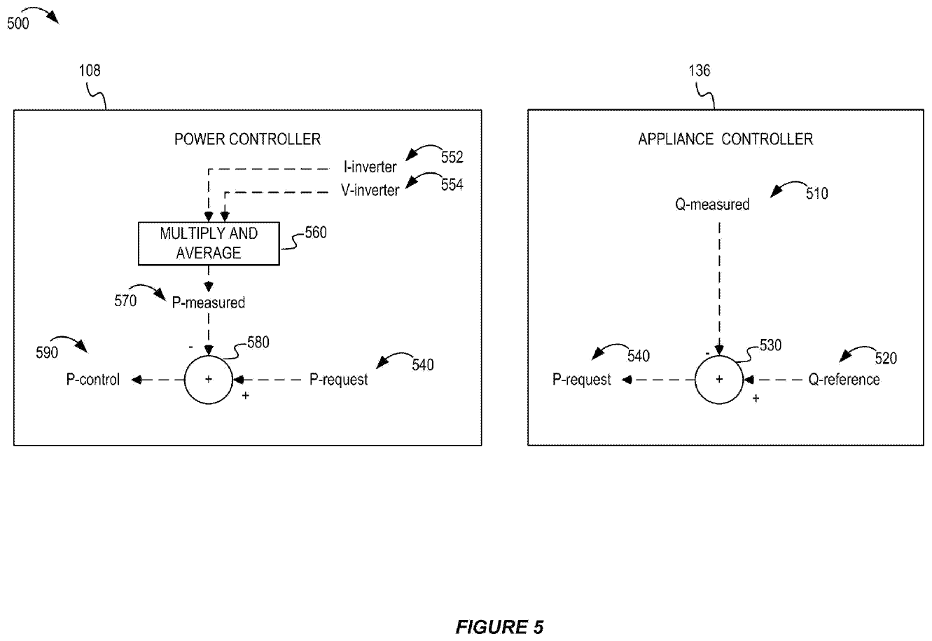

FIG. 5 shows a block diagram conceptually illustrating an example power negotiation and control. The operations of the Power Transmitter and Power Receiver are illustrated in terms of the power controller 108 and the appliance controller 136, respectively. During the connected phase, the appliance controller 136 may transmit a Requested Power (P-request 540) to reserve an amount of power. The Power Transmitter may accept or reject the P-request. If the Power Transmitter accepts the P-request, the P-request may be referred to as the Negotiated Power.

During the power transfer phase, the Power Receiver (appliance controller 136) may modify the power request P-request 540 based on an error calculation 530 between a reference quantity (Q-reference 520) and an actual measured quantity (Q-measured 510). The quantity Q may refer to voltage, speed, torque, temperature, or other parameter associated with operating the load. For example, the Q-measured 510 may be obtained by the sensor 162 described with reference to FIG. 1. The Q-reference 520 may be obtained based on the load setting 164 described with reference to FIG. 1.

The Power Transmitter (power controller 108) may adjust a power control setting (P-control 590) based on the P-request 540 and a measured power transmission (P-measured 570). P-measured 570 may be determined (shown at block 560) by an average of multiplying inverter current (I-inverter 552) and inverter voltage (V-inverter 554). The I-inverter 552 and the V-inverter 554 may be obtained using sensors, such as sensors 152 described with reference to FIG. 1. An error calculation 580 can determine the difference between the P-measured 570 and the P-request 540 to produce the P-control 590 value.

The operations described with reference to FIG. 5 illustrate a problem that exists in some power negotiation techniques. The P-request 540 value is not well defined in wireless power systems, which has led to some confusion about how it should be calculated. Some traditional systems calculate the P-request 540 to include an estimate of PTx-loss, PRx-loss, and either a load power requirement or a power rating of the load. However, the appliance controller 136 may not know the PTx-loss or have an effective means to measure or detect the PTx-loss. Consequently, the P-request 540 may include an over-inflated value causing the Power Transmitter to reserve more power than is necessary to power the load. Furthermore, some Power Receivers may use different offsets or calculations for PTx-loss, making the reliability of a Negotiated Power level impractical for a Power Transmitter that supports different types of Power Receivers.

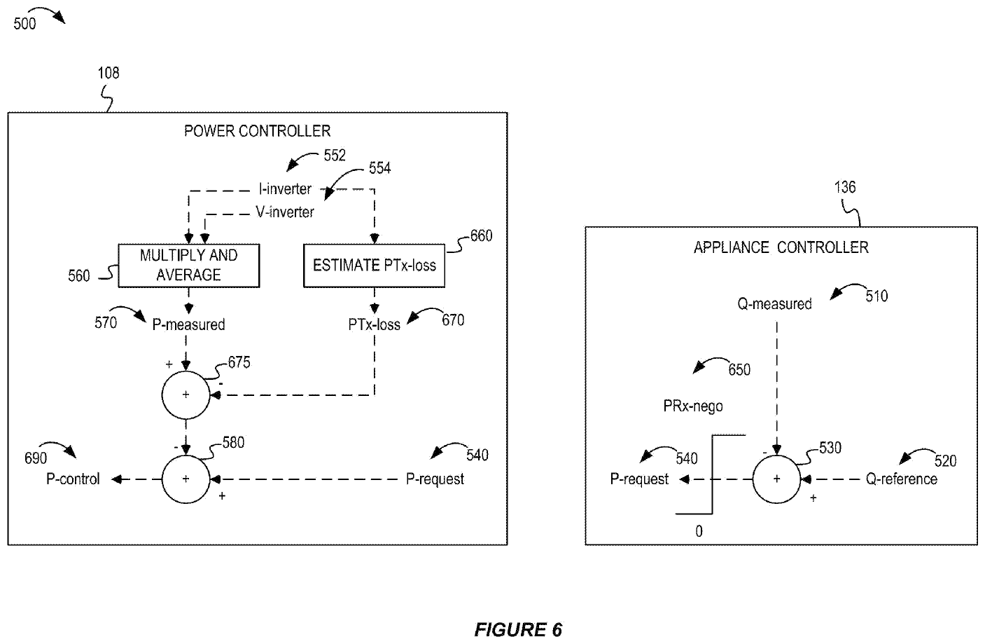

FIG. 6 shows a block diagram conceptually illustrating an example power negotiation and control that takes into account power transmission losses (PTx-loss) estimated by a Power Transmitter. The features in FIG. 6 are equivalent to those with corresponding reference numerals in FIG. 5. However, one difference is that the initial P-request 540 (during the connected phase) is defined to explicitly exclude the PTx-loss since the PTx-loss will be estimated or calculated by the Power Transmitter.

In the connected phase, the Power Receiver (appliance controller 136) communicates a power negotiation value (PRx-nego). The PRx-nego 650 may take the same form as a P-request 540 except that the PRx-nego 650 does not include PTx-loss. Rather, the PRx-nego 650 may be based on a power rating of the load and estimated power receiver losses (PRx-loss). In some implementations, the PRx-loss may be measured during manufacturing and stored or otherwise programmed into the appliance controller 136. Misalignment and K-factor may only insignificantly impact PRx-loss (as compared to PTx-loss).

The Power Transmitter (power controller 108) may estimate PTx-loss. During the connected phase (prior to power transfer), the PTx-loss may be an estimate based on a value stored in memory, a calculation based on an estimated power or otherwise programmed. In the connected phase, the Power Transmitter may estimate the PTx-loss since an actual PTx-loss may not be measured until the power transfer phase. To estimate the PTx-loss, the power controller 108 may estimate a copper loss (PTx-copper-loss) associated with a primary coil of the Power Transmitter. For example, the copper loss may be calculated using a product of a resistance (R) associated with the primary coil and a square of an estimated rated current (Iᵢₙᵥ²) associated with an inverter of the Power Transmitter to meet the PRx-nego 650. The power controller 108 also may estimate other losses and include the other losses in the estimated PTx-loss. For example, other losses may include power transmission losses associated with electronics, a capacitor, friendly metals, ferrites, or any combination thereof, associated with the Power Transmitter to meet the PRx-nego

In some implementations, the PTx-loss may be estimated based on a K-factor estimate or other estimation of the coupling factor between the Power Transmitter and the Power Receiver. The Negotiated Power (P-nego) may be based on the PRx-nego 650 plus the estimated PTx-loss.

During power transfer phase, the Power Receiver (appliance controller 136) may adjust the Requested Power by sending a new P-request 540 during the power transfer phase. In the power transfer phase, the P-request 540 may be limited to a maximum value equal to the PRx-nego 650. PTx may measure PTx-loss 670 and measured power transmission (P-measured 570). The P-measured 570 may be determined as described with reference to FIG. 5. In some implementations, the P-measured 570 can be determined based on an average of the product of the direct current (DC) input voltage to the inverter and the DC current input of the inverter. The PTx-loss 670 may be calculated (shown at block 660) based on one or more of the addition of PTx-copper-loss, losses in the PTx ferrites, friendly metals, and the losses in the electronics and other components in the tank circuit. For example, the PTx-copper-loss may be calculated (formula 1) as a product of a resistance (R) associated with a primary coil of the Power Transmitter and a square of a measured current (Iᵢₙᵥ²) associated with the primary coil.

PTx-copper-loss=Iᵢₙᵥ²R (1)

The example calculation for PTx-copper-loss is just one example and other formulas or calculations may be envisioned within the scope of this disclosure.

The Power Transmitter (power controller 108) may add the P-measured 570 and the PTx-loss 670 (as a negative value) to determine an estimated transmitted power. An error calculation 580 can determine the difference between the estimated transmitted power and the P-request 540 to produce the P-control 690 value.

In some implementations, the Power Transmitter may internally re-adjust the P-nego (=PRx-nego+PTx-losses) based on operating conditions to meet a max demand of PRx-nego by the receiver. Thus, if the measured PTx-loss (during power transfer phase) is different from the estimated PTx-loss (during connected phase), the Power Transmitter can adjust the amount of reserved power (P-nego) to accommodate the change in PTx-loss. In some implementations, the Power Transmitter may initiate a re-negotiation (either during power transfer phase or connected phase) if the PRx-nego cannot be met due to its Available Power or operating conditions.

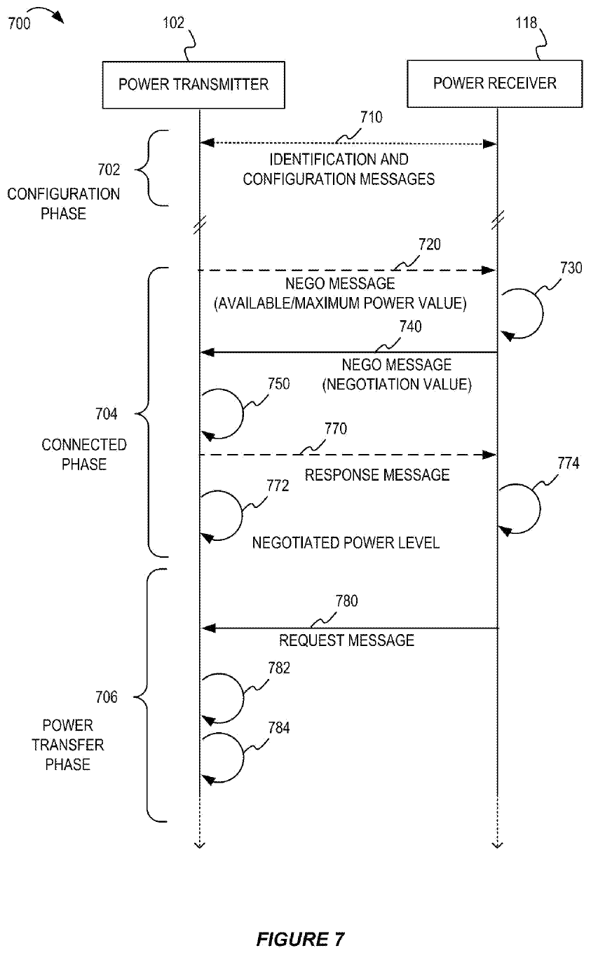

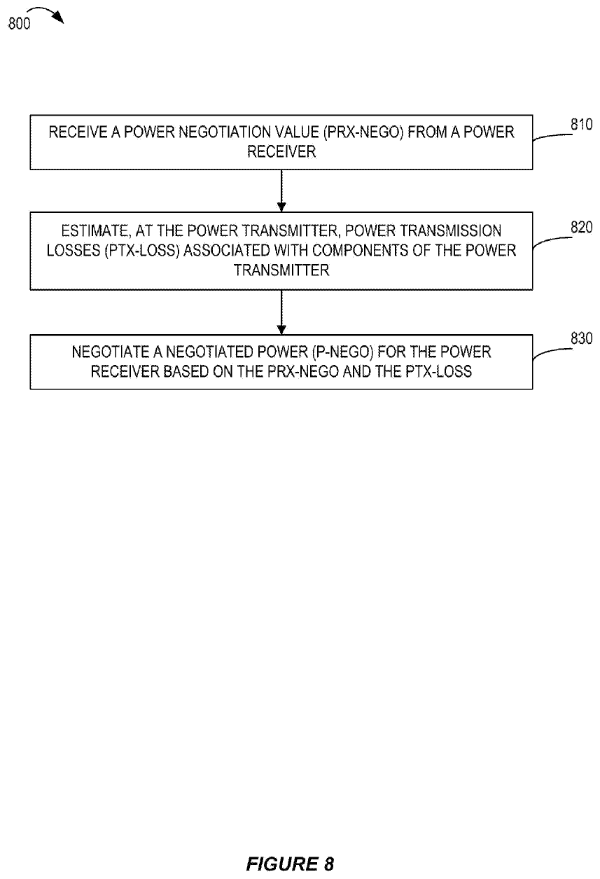

FIG. 7 shows a message flow diagram 700 conceptually illustrating an example power negotiation. A Power Transmitter 102 and a Power Receiver 118 may establish communication during a configuration phase 702 and exchange identification and configuration messages 710. In the connected phase 704, the Power Transmitter 102 and the Power Receiver 118 may perform a power negotiation. In some implementations, the Power Transmitter 102 may determine and communicate a negotiation message 720 that indicates an Available Power or a Maximum Power. At 730, the Power Receiver 118 may determine a power negotiation value (PRx-nego). The negotiation value may be based on a power rating of the Power Receiver 118 and power reception losses (PRx-loss). The PRx-loss may be estimated, calculated, measured or programmatically configured. The Power Receiver 118 may communicate a negotiation message 740 that includes the power negotiation value (PRx-nego). At 750, the Power Transmitter 102 may estimate power transmission losses (PTx-loss). The PTx-loss may be estimated, calculated, measured or programmatically configured.

If the Power Transmitter 102 can reserve the amount of power that corresponds to the power negotiation value (PRx-nego) plus the PTx-loss, the Power Transmitter 102 may communicate a response message 770 indicating that the Power Transmitter 102 accepts the power negotiation value (PRx-nego). Otherwise, if the Power Transmitter 102 cannot reserve the amount of power that corresponds to the power negotiation value (PRx-nego) plus the PTx-loss, the Power Transmitter 102 may communicate a response message 770 indicating that the Power Transmitter 102 rejects the power negotiation value (PRx-nego). In some implementations, the Power Transmitter 102 may communicate a negotiation message in addition to, or lieu of, the response message 770 to indicate a different proposed power negotiation value. In some implementations, the different proposed power negotiation value by the transmitter may correspond to the available power minus the estimated losses in the transmitter.

Continuing with FIG. 7, in the illustrated example, the Power Transmitter 102 has accepted the power negotiation value. At 772, the Power Transmitter 102 configures the Negotiated Power based on the power negotiation value (PRx-nego) and the PTx-loss. The Available Power for the power supply apparatus may be reduced by the Negotiated Power so that it is reserved for the Power Transmitter 102. At 774, the Power Receiver 118 may configure the power negotiation value (PRx-nego) as a maximum limit for subsequent power request messages.

During the power transfer phase 706, the Power Receiver 118 may transmit a power request message 780 or other feedback message to request an adjustment to the wireless power transmission. For example, the power request message 780 may include a P-request as described with reference to FIG. 6. The P-request may be limited such that it does not exceed the power negotiation value (PRx-nego) that was accepted by the Power Transmitter 102.

At 782, the Power Transmitter 102 may calculate the PTx-loss based on measurements at the inverter of the Power Transmitter 102. At 784, the Power Transmitter 102 may determine a new operating parameter to satisfy the P-request taking into account the calculated PTx-loss.

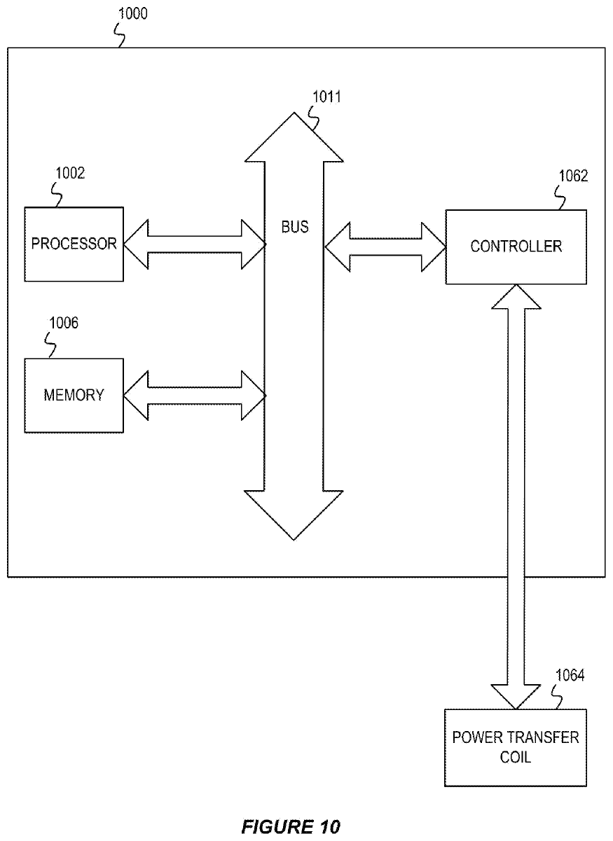

FIG. 8 shows a flow diagram illustrating example operations of a process 800 performed by a Power Transmitter. The operations of the process 800 may be implemented by a Power Transmitter as described herein. For example, the process 800 may be performed by a Power Transmitter 102 or any component thereof (such as a power controller 108) described with reference to FIG. 1, 5, or 6. The process 800 may implement any of the operations described with reference to the system state diagram 300 described with reference to FIG. 3, the power negotiation example described with reference to FIG. 4, or the message flow diagram 700 described with reference to FIG. 67. In some implementations, the process 800 may be performed by an apparatus 1000 such as described with reference to FIG. 10. For brevity, the operations are described as performed by a Power Transmitter.

At block 810, the Power Transmitter may receive a power negotiation value (PRx-nego) from a Power Receiver. At block 820, the Power Transmitter may estimate power transmission losses (PTx-loss) associated with components of the Power Transmitter. At block 830, the Power Transmitter may negotiate a Negotiated Power (P-nego) for the Power Receiver based on the PRx-nego and the PTx-loss.

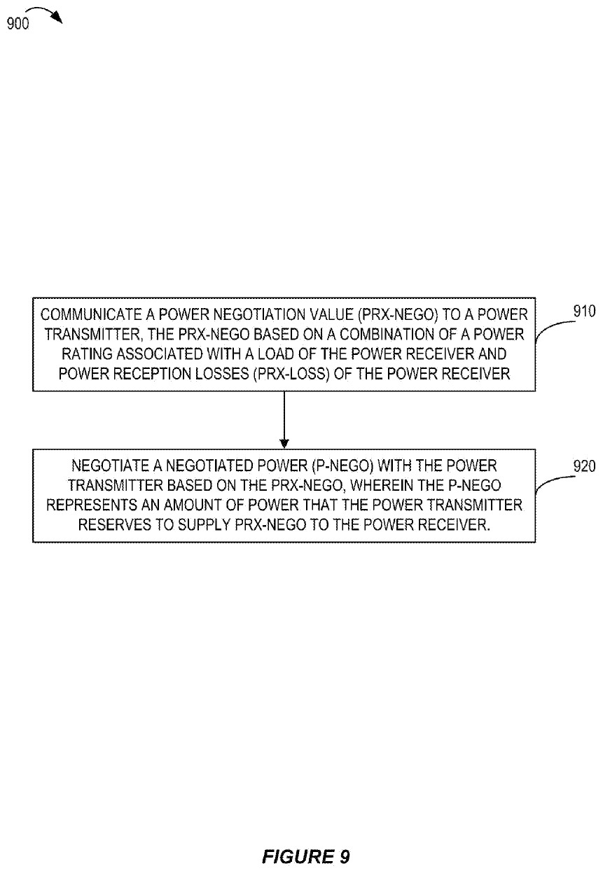

FIG. 9 shows a flow diagram illustrating example operations of a process 900 performed by a Power Receiver. The operations of the process 900 may be implemented by a Power Receiver as described herein. For example, the process 900 may be performed by a Power Receiver 118 or any component thereof (such as an appliance controller 136) described with reference to FIG. 1, 5, or 6. The process 900 may implement any of the operations described with reference to the system state diagram 300 described with reference to FIG. 3 or the message flow diagram 700 described with reference to FIG. 7. In some implementations, the process 900 may be performed by an apparatus 1000 such as described with reference to FIG. 10. For brevity, the operations are described as performed by a Power Receiver.

At block 910, the Power Receiver may communicate a power negotiation value (PRx-nego) to a Power Transmitter. The PRx-nego may be based on a combination of a power rating associated with a load of the Power Receiver and power reception losses (PRx-loss) of the Power Receiver. At block 920, the Power Receiver may negotiate a Negotiated Power (P-nego) with the Power Transmitter based on the PRx-nego. The P-nego represents an amount of power that the Power Transmitter reserves to supply PRx-nego to the Power Receiver.

FIG. 10 shows a block diagram of an example apparatus for use in wireless power system. In some implementations, the apparatus 1000 may be a Power Transmitter (such as the Power Transmitter 102) described herein. In some implementations, the apparatus 1000 may be an example of the power controller 108 described with reference to any of the Figures herein. In some implementations, the apparatus 1000 may be a Power Receiver (such as the Power Receiver 118) described herein. In some implementations, the apparatus 1000 may be an example of the appliance controller 136 described with reference to any of the Figures herein.

The apparatus 1000 can include a processor 1002 (possibly including multiple processors, multiple cores, multiple nodes, or implementing multi-threading, etc.). The apparatus 1000 also can include a memory 1006. The memory 1006 may be system memory or any one or more of the possible realizations of computer-readable media described herein. The apparatus 1000 also can include a bus 1011 (such as PCI, ISA, PCI-Express, HyperTransport®, InfiniBand®, NuBus,® AHB, AXI, etc.). The apparatus 1000 may include one or more controller(s) 1062 configured to manage a power transfer coil 1064 (such as a primary or secondary coil. In some implementations, the controller(s) 1062 can be distributed within the processor 1002, the memory 1006, and the bus 1011. The controller(s) 1062 may perform some or all of the operations described herein. For example, the controller(s) 1062 may be a power controller, such as the power controller 108 described with reference to any of FIG. 1, 5, or 6. Alternatively, the controller(s) 1062 may be an appliance controller, such as the appliance controller 136 described with reference to any of FIG. 1, 5, or 6.

The memory 1006 can include computer instructions executable by the processor 1002 to implement the functionality of the implementations described with reference to FIGS. 1-9. Any one of these functionalities may be partially (or entirely) implemented in hardware or on the processor 1002. For example, the functionality may be implemented with an application specific integrated circuit, in logic implemented in the processor 1002, in a co-processor on a peripheral device or card, etc. Further, realizations may include fewer or additional components not illustrated in FIG. 10. The processor 1002, the memory 1006, and the controller(s) 1062 may be coupled to the bus 1011. Although illustrated as being coupled to the bus 1011, the memory 1006 may be coupled to the processor 1002.

The figures, operations, and components described herein are examples meant to aid in understanding example implementations and should not be used to limit the potential implementations or limit the scope of the claims. Some implementations may perform additional operations, fewer operations, operations in parallel or in a different order, and some operations differently.

The foregoing disclosure provides illustration and description but is not intended to be exhaustive or to limit the aspects to the precise form disclosed. Modifications and variations may be made in light of the above disclosure or may be acquired from practice of the aspects. While the aspects of the disclosure have been described in terms of various examples, any combination of aspects from any of the examples is also within the scope of the disclosure. The examples in this disclosure are provided for pedagogical purposes. Alternatively, or in addition to the other examples described herein, examples include any combination of the following implementation options (enumerated as clauses for clarity).

### Clauses

Clause 1. A method performed by a Power Transmitter of a wireless power system, including: receiving a power negotiation value (PRx-nego) from a Power Receiver; estimating, at the Power Transmitter, power transmission losses (PTx-loss) associated with components of the Power Transmitter; and negotiating a Negotiated Power (P-nego) for the Power Receiver based on the PRx-nego, and the PTx-loss.

Clause 2. The method of clause 1, where the P-nego represents an amount of power that the Power Transmitter agrees to reserve for the Power Receiver.

Clause 3. The method any one of clauses 1-2, where the PRx-nego is associated with a load requirement of a load of the Power Receiver.

Clause 4. The method any one of clauses 1-3, where the PRx-nego is based on a combination of a power rating associated with the load and power reception losses (PRx-loss) of the Power Receiver.

Clause 5. The method any one of clauses 1-4, where the PRx-nego from the Power Receiver does not account for the PTx-loss.

Clause 6. The method of any one of clauses 1-5, where, during a connected phase, estimating the PTx-loss includes estimating power transmission losses associated with at least one member of a group consisting of: a copper loss associated with a primary coil of the Power Transmitter, the copper loss calculated using a product of a resistance (R) associated with the primary coil and a square of an estimated rated current (Iinv2) associated with an inverter of the Power Transmitter to meet the PRx-nego; other losses associated with electronics, a capacitor, friendly metals, ferrites, or any combination thereof, associated with the Power Transmitter to meet the PRx-nego.

Clause 7. The method of any one of clauses 1-5, further including, during a power transfer phase: controlling a transmission of wireless power to the Power Receiver using an operating control parameter that is based, at least in part, on a receiver power request P-request.

Clause 8. The method of clause 7, further including, during the power transfer phase: determining a measured power (P-measured) based on an average of an inverter current (Iinv) multiplied by inverter voltage (Vinv) over a time period; determining a measured PTx-loss over the same time period, and adjusting the operating control parameter to control the transmission of wireless power based on the P-measured, the measured PTx-loss, and a power request (P-request) from the Power Receiver indicating a Requested Power that is less than or equal to the PRx-nego.

Clause 9. The method of any one of clauses 7-8, where, during the power transfer phase, determining the measured PTx-loss includes determining power transmission losses associated with at least one member of a group consisting of: a copper loss associated with a primary coil of the Power Transmitter, the copper loss calculated using a product of a resistance (R) associated with the primary coil and a square of a measured current (Iinv2) associated with an inverter of the Power Transmitter; other losses associated with electronics, a capacitor, friendly metals, ferrites, or any combination thereof, associated with the Power Transmitter.

Clause 10. The method of any one of clauses 1-9, where estimating the PTx-loss includes: obtaining the PTx-loss from a memory of the Power Transmitter.

Clause 11. The method of any one of clauses 1-10, where estimating the PTx-loss includes: adjusting the PTx-loss based, at least in part, on a coupling factor (K-factor) indicating an efficiency of a wireless coupling between the Power Transmitter and the Power Receiver.

Clause 12. A method performed by a Power Receiver of a wireless power system, including: communicating a power negotiation value (PRx-nego) to a Power Transmitter, the PRx-nego based on a combination of a power rating associated with a load of the Power Receiver and power reception losses (PRx-loss) of the Power Receiver; and negotiating a Negotiated Power (P-nego) with the Power Transmitter based on the PRx-nego, where the P-nego represents an amount of power that the Power Transmitter reserves to supply PRx-nego to the Power Receiver. 13. The method of clause 12, where the PRx-nego from the Power Receiver does not account for power transmission losses (PTx-loss) of the Power Transmitter.

Clause 14. The method of any one of clauses 14-13, further including: communicating a power request (P-request) to the Power Transmitter during power transfer phase, the P-request indicating a Requested Power that is less than or equal to the PRx-nego; and receiving a transmission of wireless power from the Power Transmitter based, at least in part, on P-request. 15. A wireless power system, including: one or more Power Transmitters; one or more communication interfaces corresponding to the one or more Power Transmitters, including at least a first communication interface corresponding to a first Power Transmitter, the first communication interface configured to receive a power negotiation value (PRx-nego) from a Power Receiver; and a controller configured to: determine an Available Power remaining from a power source coupled to the wireless power system based on reserved power amounts for each of the one or more Power Transmitters; estimate a power transmission losses (PTx-loss) associated with components of the first Power Transmitter; and reserve a first reserved power amount for the first Power Transmitter, where the first reserved power amount is based on a combination of the PRx-nego and the PTx-loss and is limited by the Available Power.

Clause 16. The wireless power system of clause 15, further including: the first communication interface configured to communicate an acceptance message to the Power Receiver.

Clause 17. The wireless power system of clause 15, further including: the controller configured to: determine that the first reserved power amount is less than the PRx-nego; and cause the first communication interface to communicate a rejection message to the Power Receiver.

Clause 18. The wireless power system of clause 17, further including: the controller configured to: calculate a second reserved power amount, lower than the first reserved power amount, based on available power and the estimated PTx-loss to meet a different PRx-nego that the Power Transmitter can satisfy; and cause the first communication interface to communicate the different PRx-nego to the Power Receiver as an alternative PRx-nego for negotiation.

Clause 19. A Power Transmitter configured to perform any one of the methods of clauses 1-11.

Clause 20. A Power Receiver configured to perform any one of the methods of clauses 12-14.

Another innovative aspect of the subject matter described in this disclosure can be implemented as an apparatus. The apparatus may include a modem and at least one processor communicatively coupled with the at least one modem. The processor, in conjunction with the modem, may be configured to perform any one of the above-mentioned methods or features described herein.

Another innovative aspect of the subject matter described in this disclosure can be implemented as a computer-readable medium having stored therein instructions which, when executed by a processor, causes the processor to perform any one of the above-mentioned methods or features described herein.

Another innovative aspect of the subject matter described in this disclosure can be implemented as a system having means for implementing any one of the above-mentioned methods or features described herein.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus used to implement the various illustrative components, logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, for example, a combination of a DSP and a microprocessor, multiple microprocessors, one or more microprocessors in conjunction with a DSP core, or any other such configuration. In some implementations, particular processes, operations and methods may be performed by circuitry that is specific to a given function.

As described above, in some aspects of the subject matter described in this specification can be implemented as software. For example, various functions of components disclosed herein, or various blocks or steps of a method, operation, process or algorithm disclosed herein can be implemented as one or more modules of one or more computer programs. Such computer programs can include non-transitory processor-executable or computer-executable instructions encoded on one or more tangible processor-readable or computer-readable storage media for execution by, or to control the operation of, a data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

Various modifications to the implementations described in this disclosure may be readily apparent to persons having ordinary skill in the art, and the generic principles defined herein may be applied to other implementations without departing from the scope of this disclosure. Thus, the claims are not intended to be limited to the implementations shown herein but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

1. A method performed by a Power Transmitter of a wireless power system, comprising:
receiving a power negotiation value (PRx-nego) from a Power Receiver;
estimating, at the Power Transmitter, power transmission losses (PTx-loss) associated with components of the Power Transmitter; and
negotiating a Negotiated Power (P-nego) for the Power Receiver based on the PRx-nego and the PTx-loss.

2. The method of claim 1, wherein the P-nego represents an amount of power that the Power Transmitter agrees to reserve for the Power Receiver.

3. The method of claim 1, wherein the PRx-nego is associated with a load requirement of a load of the Power Receiver.

4. The method of claim 1, wherein the PRx-nego is based on a combination of a power rating associated with a load of the Power Receiver and power reception losses (PRx-loss) of the Power Receiver.

5. The method of claim 1, wherein the PRx-nego from the Power Receiver does not account for the PTx-loss.

6. The method of claim 1, wherein, during a connected phase, estimating the PTx-loss includes estimating power transmission losses associated with at least one member of a group consisting of:
a copper loss associated with a primary coil of the Power Transmitter, the copper loss calculated using a product of a resistance (R) associated with the primary coil and a square of an estimated rated current (Iᵢₙᵥ²) associated with an inverter of the Power Transmitter to meet the PRx-nego; and
other losses associated with electronics, a capacitor, friendly metals, ferrites, or any combination thereof, associated with the Power Transmitter to meet the PRx-nego.

7. The method of claim 1, further comprising, during a power transfer phase:
controlling a transmission of wireless power to the Power Receiver using an operating control parameter that is based, at least in part, on a receiver power request P-request.

8. The method of claim 7, further comprising, during the power transfer phase:
determining a measured power (P-measured) based on an average of an inverter current (Iᵢₙᵥ) multiplied by inverter voltage (Vᵢₙᵥ) over a time period;
determining a measured PTx-loss over the same time period; and
adjusting the operating control parameter to control the transmission of wireless power based on the P-measured, the measured PTx-loss, and a power request (P-request) from the Power Receiver indicating a Requested Power that is less than or equal to the PRx-nego.

9. The method of claim 7, wherein, during the power transfer phase, determining the measured PTx-loss includes determining power transmission losses associated with at least one member of a group consisting of:
a copper loss associated with a primary coil of the Power Transmitter, the copper loss calculated using a product of a resistance (R) associated with the primary coil and a square of a measured current (Iᵢₙᵥ²) associated with an inverter of the Power Transmitter; and
other losses associated with electronics, a capacitor, friendly metals, ferrites, or any combination thereof, associated with the Power Transmitter.

10. The method of claim 1, wherein estimating the PTx-loss includes:
obtaining the PTx-loss from a memory of the Power Transmitter.

11. The method of claim 1, wherein estimating the PTx-loss includes:
adjusting the PTx-loss based, at least in part, on a coupling factor (K-factor) indicating an efficiency of a wireless coupling between the Power Transmitter and the Power Receiver.

12. A method performed by a Power Receiver of a wireless power system, comprising:
communicating a power negotiation value (PRx-nego) to a Power Transmitter, the PRx-nego based on a combination of a power rating associated with a load of the Power Receiver and power reception losses (PRx-loss) of the Power Receiver; and
negotiating a Negotiated Power (P-nego) with the Power Transmitter based on the PRx-nego, wherein the P-nego represents an amount of power that the Power Transmitter reserves to supply PRx-nego to the Power Receiver.

13. The method of claim 12, wherein the PRx-nego from the Power Receiver does not account for power transmission losses (PTx-loss) of the Power Transmitter.

14. The method of claim 12, further comprising:
communicating a power request (P-request) to the Power Transmitter during power transfer phase, the P-request indicating a Requested Power that is less than or equal to the PRx-nego; and
receiving a transmission of wireless power from the Power Transmitter based, at least in part, on P-request.

15. A wireless power system, comprising:
one or more Power Transmitters;
one or more communication interfaces corresponding to the one or more Power Transmitters, including at least a first communication interface corresponding to a first Power Transmitter, the first communication interface configured to receive a power negotiation value (PRx-nego) from a Power Receiver; and
a controller configured to:
determine an Available Power remaining from a power source coupled to the wireless power system based on reserved power amounts for each of the one or more Power Transmitters;
estimate a power transmission losses (PTx-loss) associated with components of the first Power Transmitter; and
reserve a first reserved power amount for the first Power Transmitter, wherein the first reserved power amount is based on a combination of the PRx-nego and the PTx-loss and is limited by the Available Power.

16. The wireless power system of claim 15, further comprising:
the first communication interface configured to communicate an acceptance message to the Power Receiver.

17. The wireless power system of claim 15, further comprising:
the controller configured to:
determine that the first reserved power amount is less than the PRx-nego; and
cause the first communication interface to communicate a rejection message to the Power Receiver.

18. The wireless power system of claim 17, further comprising:
the controller configured to:
calculate a second reserved power amount, lower than the first reserved power amount, based on available power and the estimated PTx-loss to meet a different PRx-nego that the Power Transmitter can satisfy; and
cause the first communication interface to communicate the different PRx-nego to the Power Receiver as an alternative PRx-nego for negotiation.

19-20. (canceled)
